(19) United States
(12) Patent Application Publication
(10) Pub. No.: US 2019/0136616 A1
(43) Pub. Date: May 9, 2019

(54) DEPLOYABLE COVER FOR A WINDOW APERTURE

(71) Applicant: John Cito, Lincroft, NJ (US)

(72) Inventor: John Cito, Lincroft, NJ (US)

(21) Appl. No.: 15/997,521

(22) Filed: Jun. 4, 2018

Related U.S. Application Data
(63) Continuation of application No. PCT/US2017/059852, filed on Nov. 3, 2017.

(51) Int. Cl. E06B 9/54

(52) U.S. Cl. CPC E06B 9/54; E06B 2009/528; E06B 2009/543

(57) ABSTRACT

A deployable window cover module includes a cover material mounted on a tensioned roller located in the window frame housing. The deployable cover material may be attached to the sash or outer part of the window and, as such, is unrolled as the window is slid open. The housing may be located in the base or top of the window frame or in the sides of the window frame.

### CROSS-REFERENCE TO RELATED APPLICATION

This is a continuation of P.C.T. international patent application number PCT/US2017/059852, filed Nov. 3, 2017.

### BACKGROUND OF THE INVENTION

The present invention relates, generally, to windows and, more particularly, to the frame of a window having an internal cover module deploying barrier material over the window aperture as the window is opened and closed with the barrier material taken from the group of screen, mesh, fabric and composite materials thereof.

### SUMMARY OF THE INVENTION

The primary object of the present invention is to provide deployable barrier material for a window aperture that is not visible until the window is opened.

Another object of the present invention is to provide windows with a cover module located within the window frame's top, bottom and/or sides for deploying the barrier material from the cover module housing.

Yet another object of the present invention is to provide the cover module housing with aperture for passage of the barrier material.

Still yet another object of the present invention is to provide the cover module housing with spooled barrier material linked to a tensioning member storing potential energy while deploying the barrier material, then used to retract the barrier material when closing the window.

An additional object of the present invention is to provide the cover module with cleaning device positioned proximate the passage aperture cleaning the barrier material as it deploys from and retracts into the housing.

A further object is to selectively prevent the barrier material from deploying by decoupling a first mating/engaging fastener member located on the free end of the barrier material and a second mating/engaging fastener member fixedly attached to the window frame.

A yet further object of the present invention is to provide a window cover material that is attachable and detachable from the sash or side of the window through releasable fastener.

An additional object of the present invention is to provide attachable detachable fasteners taken from the group of hook and loop, snaps, magnets and spring locks.

A still further object of the present invention is to provide a window screen module with the deployable screen mounted on a roller and where the roller has an internal spring fixedly attached at one end to a non rotating housing member to supply necessary tension.

Additional objects of the present invention will appear as the description proceeds.

The present invention overcomes the shortcomings of the prior art by providing a window frame with an internal window aperture cover tensioned within a housing that deploys through a cleaning device lined slot when the window is opened and when retracted with the lined slot cleaning the cover as it moves in and out of its stored location.

More particularly, the present invention provides a deployable window cover, which includes a rectangular window frame having four sides, including a top, a base, and two sides, a sliding window portion, wherein the sliding window portion fits into, and moves in, channels located in the rectangular window frame and in which the sliding window portion has a closed position wherein the rectangular window frame is substantially filled by the sliding window portion and an open position in which the rectangular window frame is partially open. A deployable cover material housing is disposed in the rectangular window frame; the deployable cover material housing including a tensioned roller holding a deployable cover material, a longitudinal slot and cleaning device located within the longitudinal slot. Detachable engagement means is provided for engaging the sliding window portion and the deployable cover material, so that when the sliding window portion is moved to the open position with the deployable cover material being moved to cover the partially open rectangular window frame.

It is thus desirable to provide a window frame with an integral cover module that deploys and retracts the barrier material as the window is opened and closed.

It is further desirable to provide the cover module embedded within the frame or sill with aperture cleaning device that cleans the barrier material as it moves into and out of its stored position within the module.

It is still further desirable to selectively prevent the barrier material from deploying by decoupling a first mating/engaging fastener member located on the free end of the barrier material and a second mating/engaging fastener member fixedly attached to the window frame.

Other objects and features of the present invention will become apparent when considered in combination with the accompanying drawing figures, which illustrate certain preferred embodiment of the present invention. It should, however, be noted that the accompanying drawing figures are intended to illustrate only select preferred embodiments of the claimed invention and are not intended as a means for defining the limits and scope of the invention.

### DESCRIPTION OF THE REFERENCED NUMERALS

Turning now descriptively to the drawings, in which similar reference characters denote similar elements throughout the several views, the figures illustrate the use of the present invention. With regard to the reference numerals used, the following numbering is used throughout the various drawing figures:
10 overview of the deployment cover of the present invention
12 window frame top
14 window frame side
16 window frame bottom or base
18 cover module housing
20 deployable window cover
22 window frame with housing in base
24 window frame with housing in side
26 window
28 window channel
30 hook and loop fastener strip
32 window cover housing slot
34 window cover housing cleaning device
36 window cover roller
38 tensioning spring coil
A1 first directional arrow
A2 second directional arrow

### BRIEF DESCRIPTION OF THE DRAWING FIGURES

In the drawing figures, wherein similar features are denoted with similar reference numerals throughout the several views:

FIG. 1 is an overview of the present invention showing both the embodiment where the screen housing is located in the bottom or base of the frame and where the housing is located in one of the sides of the frame;

FIG. 2 is a perspective view of the present invention;

FIG. 3 is a perspective view of the screen housing of the present invention located in the base of the window frame;

FIG. 4 is a perspective view of the cover module housing of the present invention located within the side of the window frame with the window closed;

FIG. 5 is a perspective view of the cover module housing of the present invention located in the side of the window frame and the screen being deployed as the window is opened;

FIG. 6 is a perspective view of the cover module housing of the present invention located within the opposite side of the window frame in respect to FIG. 4 and also with the window closed;

FIG. 7 is a perspective view of the cover module housing of the present invention as seen in FIG. 6 with the screen being deployed as the window is opened;

FIG. 8 is a partial perspective detailed view of the retractable cover module housing; and,

FIG. 9 is a partial perspective detailed view of the retractable cover module housing with the screen being deployed.

### DETAILED DESCRIPTION OF THE DRAWING FIGURES AND PREFERRED EMBODIMENTS

The following discussion describes in detail one embodiment of the invention and several variations of the preferred embodiment. This discussion should not be construed, however, as limiting the invention to those particular embodiments, practitioners skilled in the art will recognize numerous other embodiments as well. For definition of the complete scope of the invention, the reader is directed to appended claims:

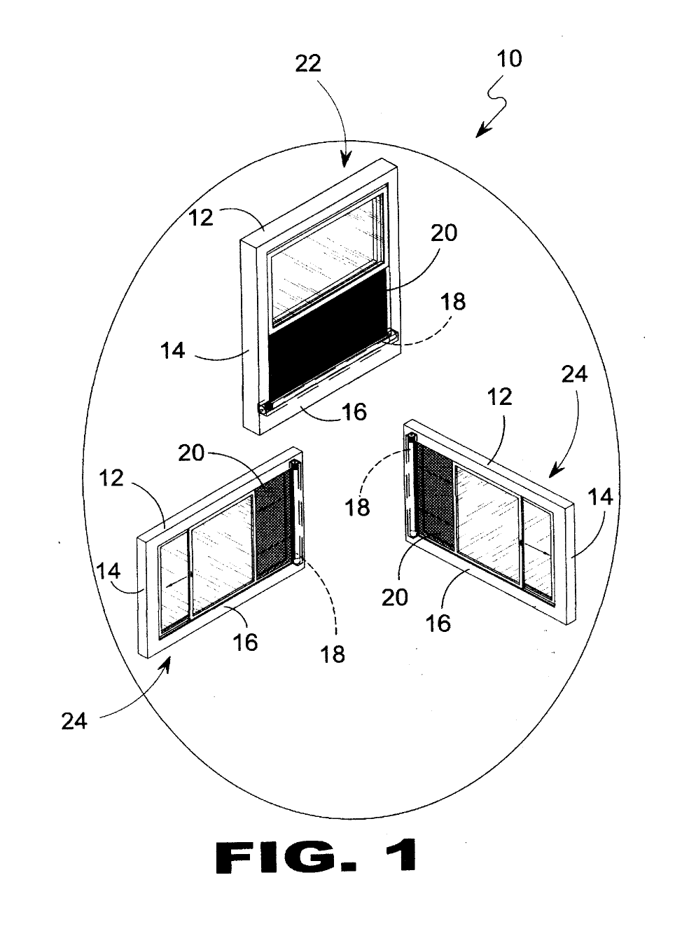

In FIG. 1 the present invention 10 is seen. In the first embodiment as indicated at 22 the cover module housing 18 is located in the bottom or base 16 of the window frame 22. In the second embodiment indicated at 24 the housing 18 is located in one of the sides 14 of the second embodiment frame 24. It should be noted that the window screen or cover housing 18 could also be located within the top portion 12 of any of the frames in the Figure. Also seen in the Figure is the deployed cover material as indicated at 20.

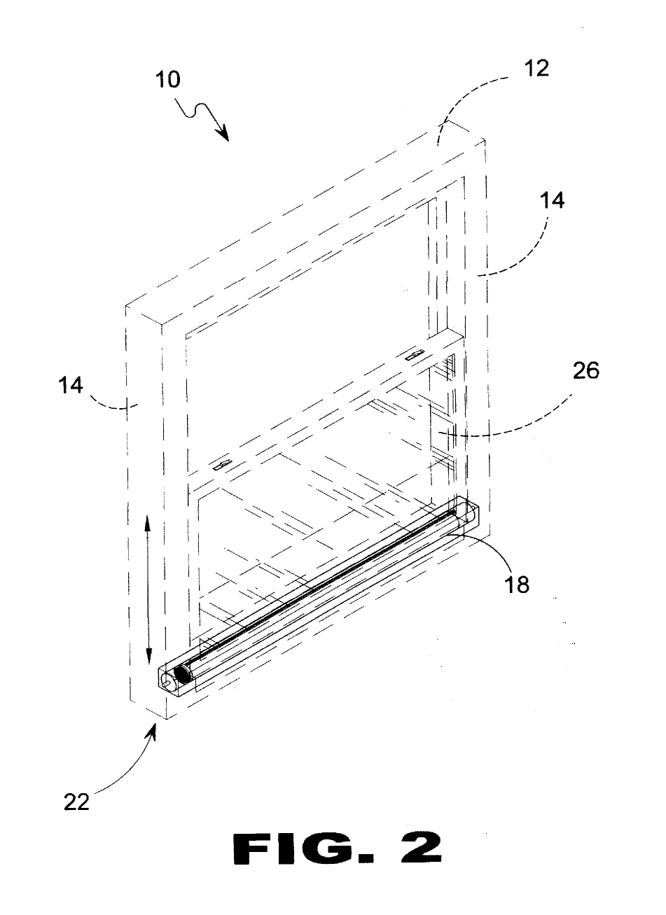

FIG. 2 shows a view of the window frame embodiment 22 with the deployable cover module housing 18 being located in the base 16 of frame 22. Sides 14 and top 12 of frame 22 are also shown. Window 26 is seen closed in the Figure.

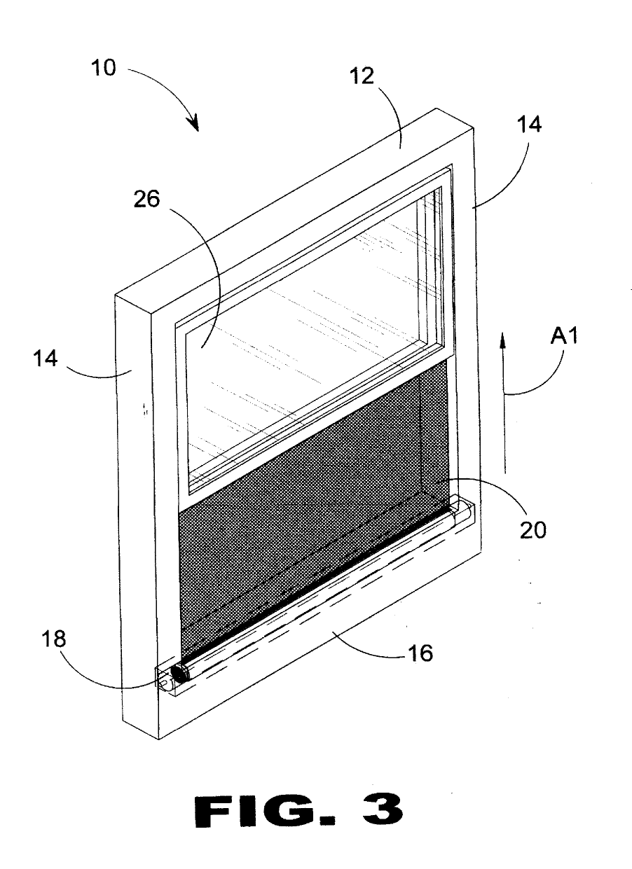

Turning to FIG. 3, we see the window frame embodiment 22 as seen in FIG. 2 in use with the cover material 20 being deployed as window 26 is opened as indicated by directional arrow A1. Sides 14 and top 12 of frame 22 are also shown and the deployable cover module housing 18 is seen disposed in base 16 of frame 22.

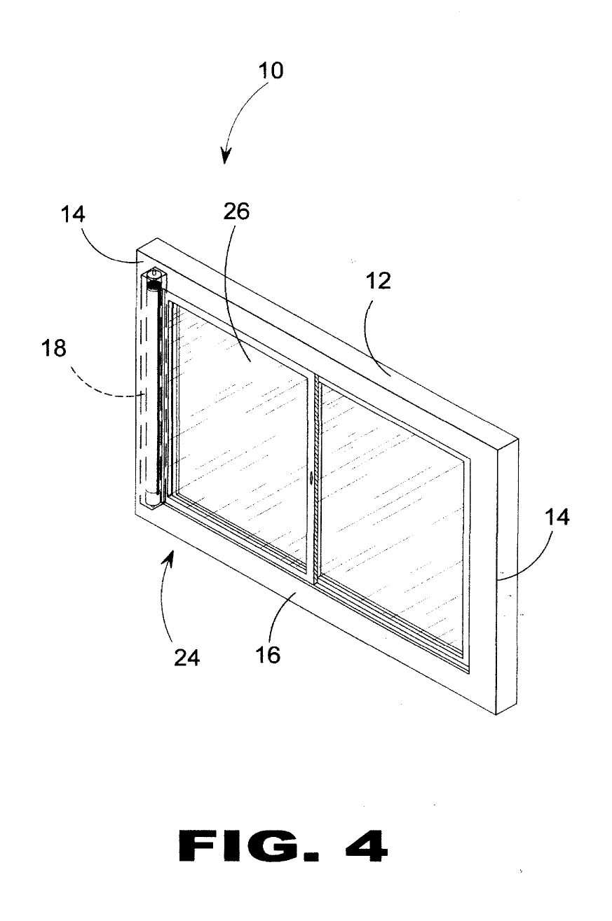

In FIG. 4 window frame embodiment 24 of present invention 10 is shown. In this embodiment 24 the deployable cover module housing 18 is located on one of the sides 14 of frame 24. The window 26 is seen closed.

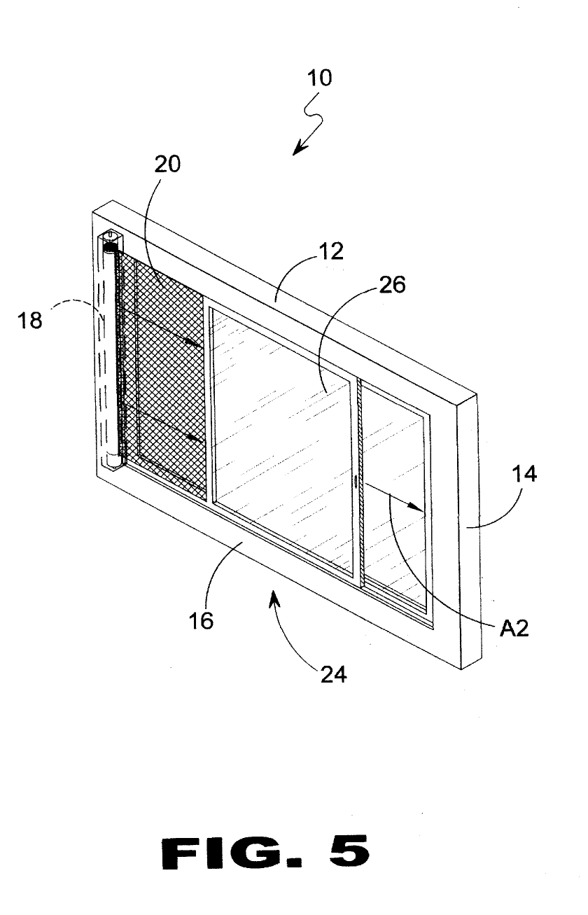

FIG. 5 shows the window frame embodiment 24 being opened as indicated by directional arrow A2 with the deployable cover material 20 in place.

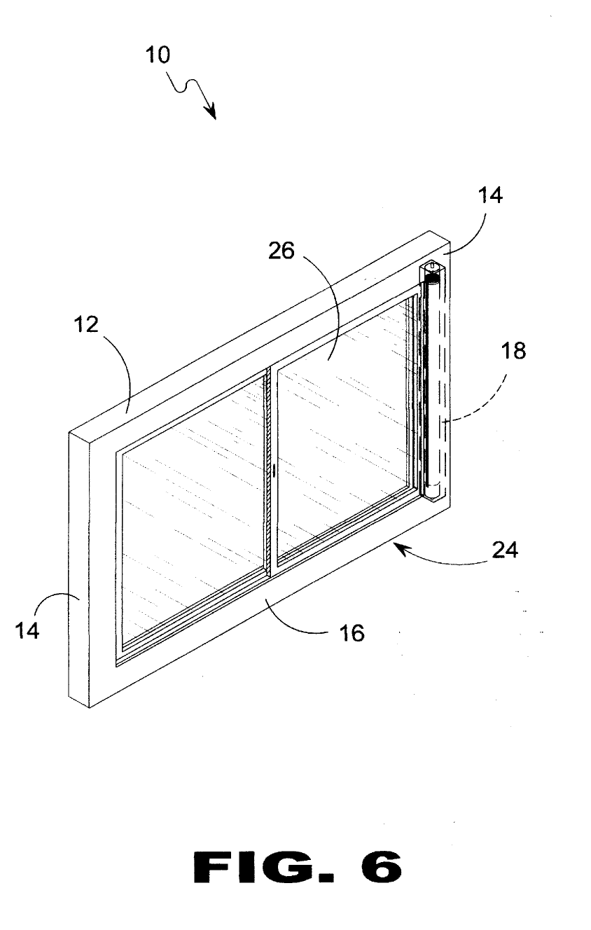

In FIG. 6 the window frame embodiment 24 is seen with the deployable cover module housing 18 being located on the opposite one of the sides 14 and with the window 26 being closed.

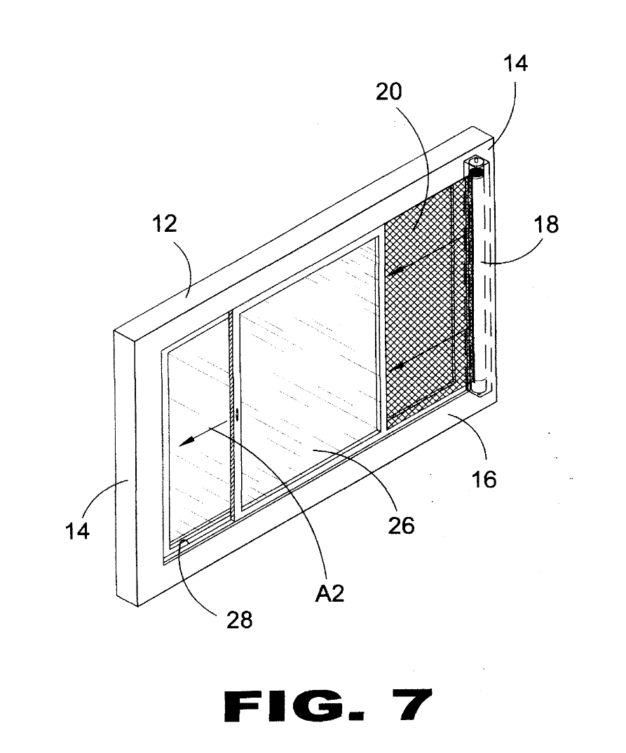

FIG. 7 shows the window frame embodiment 24 as seen in FIG. 6 being opened as indicated by directional arrow A2. Window cover material 20 is deployed as shown. Note that window channel 28 is pointed out in this Figure. The window 26 travels in these channels 28 when the window cover material 20 is deployed and recovered.

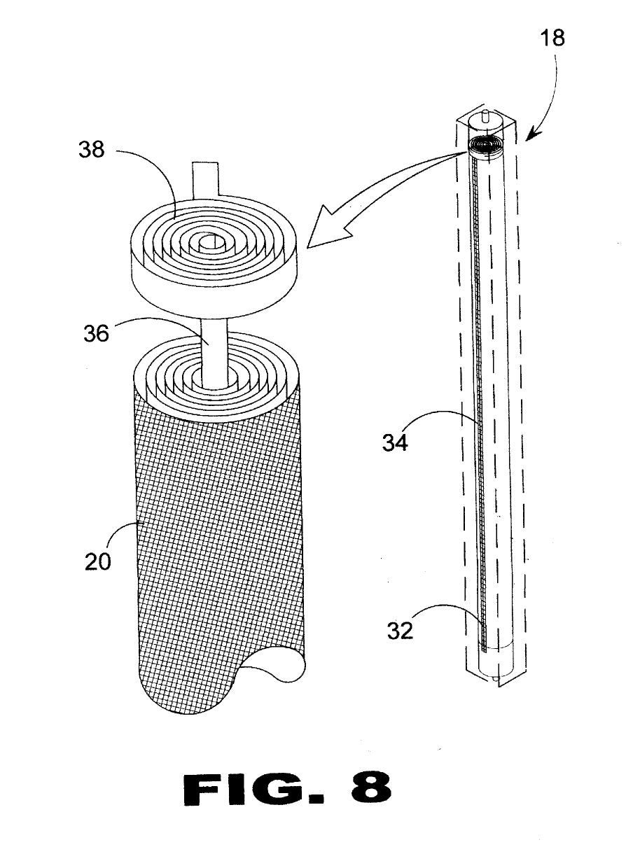

Turning now to FIG. 8 the details of the cover housing 18 are shown. Window cover material 20 is attached to a roller 36 and is tensioned by a coil spring 38. The cover housing 18 includes a slot 32 and located within this slot 32 is cleaning device 34 that serves to clean the deployable cover material 20 as it is deployed and retrieved.

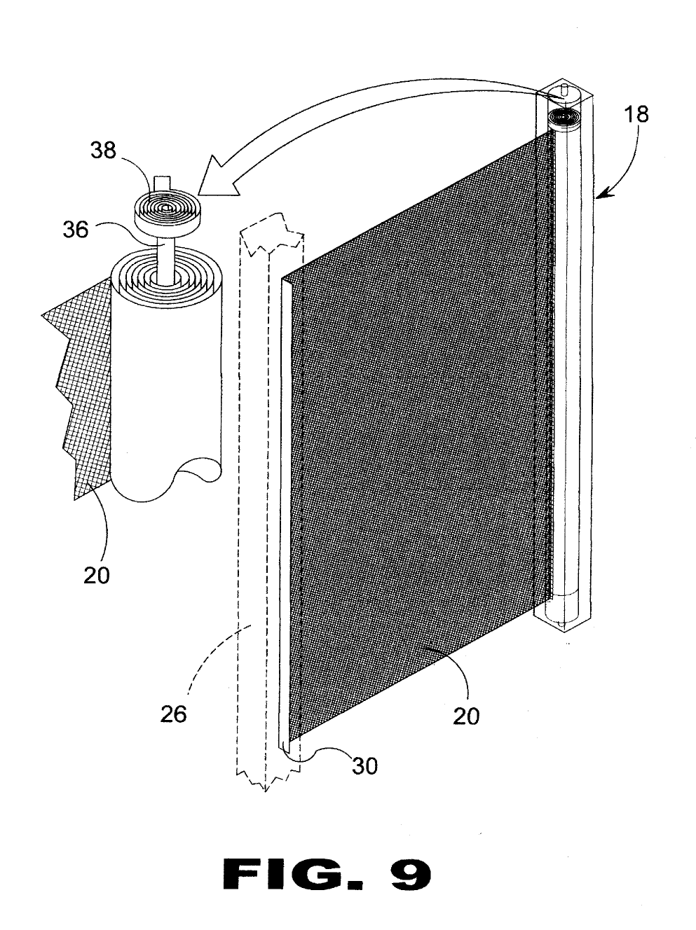

In FIG. 9 further details of the cover housing 18 are seen with the tension coil spring 38 being shown tightening as the cover material 20 is deployed. Screen 20, in the embodiments described herein is attached to the window by cooperating hook and loop type fasteners (Velcro®) indicated at 30. It should be emphasized that a number of methods could be used to removably engage and disengage the deployable cover material 20 to the window 26. Mechanical hooks, for example, snaps, magnets, spring locks or many other types of attachment mechanisms could be used.

While only several embodiments of the present invention have been shown and described, it will be obvious to those skilled in the art that many modifications may be made to the present invention without departing from the spirit and scope thereof.

What is claimed is:

1. A deployable window covering, comprising:
a rectangular window frame having four sides, including a top, a base, and two sides;
a sliding window portion, where said sliding window portion fits into and moves in channels located in said rectangular window frame and where said sliding window portion has a closed position where said rectangular window frame is substantially filled by said sliding window portion and an open position where said rectangular window frame is partially open;
a deployable cover material housing disposed in said rectangular window frame, said deployable cover material housing including a tensioned roller holding a deployable cover material, a longitudinal slot, and cleaning device located within said longitudinal slot; and
a detachable engagement means for engaging said sliding window portion and said deployable cover material: such that when said sliding window portion is moved to said open position, said deployable cover material is moved to cover said partially open rectangular window frame.

2. The deployable window covering according to claim 1, wherein said cover material is taken from the group of screen, mesh and fabric.

3. The deployable window covering according to claim 1, wherein said cleaning device engages the cover material as it deploys from the window cover housing and retracts into the window cover housing.

4. The deployable window covering according to claim 3, wherein said cleaning device is taken from the group of roller and brush-like material.

5. The deployable window covering module according to claim 1, wherein said detachable engagement means comprises detachable fasteners.

6. The deployable window covering module according to claim 3, wherein said detachable fasteners is taken from the group of snaps, hook and loop, magnets and spring locks.

7. The deployable window covering module according to claim 1, wherein said tensioned roller includes a coil spring.

8. The deployable window covering module according to claim 1, wherein said deployable cover material housing is located in said base side of said rectangular window frame.

9. The deployable window covering module according to claim 8, wherein said tensioned roller includes a coil spring.

10. The deployable window covering module according to claim 1, wherein said deployable cover material housing is located in said top side of said rectangular window frame.

11. The deployable window cover module according to claim 10, wherein said tensioned roller includes a coil spring.

12. The deployable window cover module according to claim 1, wherein said deployable screen housing is located in one of said two sides of said rectangular window frame.
